(19) United States
(12) Patent Application Publication
(10) Pub. No.: US 2020/0383526 A1
(43) Pub. Date: Dec. 10, 2020

(54) Shower Beer Holder with Speaker

(71) Applicant: Jack Mosseri, New York, NY (US)

(72) Inventor: Jack Mosseri, New York, NY (US)

(21) Appl. No.: 16/891,167

(22) Filed: Jun. 3, 2020

Related U.S. Application Data
(60) Provisional application No. 62/857,234, filed on Jun. 4, 2019.

(51) Int. Cl. A47K 3/28; H04R 1/02; H04R 3/00; A47G 29/093

(52) U.S. Cl. CPC A47K 3/281; H04R 1/028; H04R 2420/05; H04R 1/026; A47G 29/093; H04R 3/00

(57) ABSTRACT

Shown is a beverage jar holder having means that can be mounted onto a wall or placed onto a flat surface. The jar is held within a cupholder-like niche, where it can be easily inserted and removed repeatedly. The base of the jar holder contains a speaker and a radio waves receiver. The receiver connects to a remote device which can broadcast music and other content through the speaker on the jar holder. The user can control volume and live tracks directly from the jar holder. A removable flap protects internal audio components from moisture. The audio control panel also contains a charging port for the onboard battery. The location of the charging port may differ from the control pad and the charging port may have a separate protective flap. This alternative configuration will further limit the possibility of water entry when the flap is moved out of place to adjust volume or switch soundtracks.

### CLAIM OF PRIORITY

This application claims priority to the US Provisional Utility Patent Application No. 62/857,234, which was filed on 4 Jun. 2019, the contents of which are incorporated herein by reference.

### FIELD OF THE INVENTION

The present invention relates to a recreational accessory containing an audio component for holding beverages suspended from a support structure.

### BACKGROUND OF THE INVENTION

Bathtub and shower activities are associated with personal hygiene and, in cases of hot bath or shower, with rest and relaxation. Humans crave rest after any long or strenuous activity, or for no reason at all. Water, especially warm water, is generally associated with a release of positive endorphins, associated with happiness and relaxation.

Another form of relaxation is an occasional and moderate consumption of wine and spirits, which contain a small percentage of alcohol by volume. Moderate consumption of spirits, such as wine and beer, has shown positive social benefits, such as increased predisposition to social interaction, elevated mood and gregariousness. Moderate consumption has also shown to have positive health effects, such as decreased stress level.

While bathing and consuming spirits may be treated as a relaxing or mood improving activity, music is used to stimulate a certain emotion that appeals to the listener. Because people are naturally drawn to different emotions, there are a plurality of music genre, each presenting its unique attraction to its listener.

The present invention seeks to optimize the merger of the three aforementioned stimulants into a common package thereby enhancing the therapeutic appeal of each activity. A user who is showering or bathing may wish to remain hydrated and in a relaxed psychological predisposition by slowly consuming a favorite alcoholic beverage while listening to a sports broadcast, a podcast or to a favorite vocal artist.

The show device is conveniently wrapped into a small package that removably attaches to a support surface, such as a wall of a shower or bath stall, or to a surface of a bathtub. The removable attachment of a device to a support surface may be accomplished using suction cups, restickable surfaces, hook and loop fasteners.

### SUMMARY OF THE INVENTION

Shown is a beverage jar holder having means to be mounted onto a wall and having a beverage container. The device is comprised of a base. Rising from the base is a barrier that curves around the base, and depending on an embodiment, leaves a gap in the front uncovered. The curvature of the barrier conforms to the curvature of a standard metaling beverage can, such as the one used for beer and carbonated drinks.

The gap in the barrier may contain a strap linking the two terminal ends of the barrier. This strap may be solid or flexible and adjustable. In embodiments having a solid curved barrier, the device may be used to preserve and prolong the chilled state of beverages held on the base, as the barrier may be refillable with water or imbued with a substance that freezes when exposed to low temperatures.

The base of the beverage holder contains a speaker, an audio amplifier, a radio transceiver, an audio control panel and a power source. The power source may be rechargeable through a charging port within the audio control panel. The transceiver is preferably linked with a device using a radio signal, where the device would then transmit an audio signal to be amplified through the speaker of the disclosed device.

### BRIEF DESCRIPTION OF THE DRAWINGS

FIGS. 1A and 1B demonstrate two perspective angles of the device and beverage jar shown in the present disclosure.

FIG. 2 is a perspective view of the present invention with the view of the speaker.

FIG. 3 shows an alternative embodiment featuring suction cups along the base.

FIG. 4 shows another alternative embodiment, showing a full cupholder; the shown cupholder preferably containing a refillable cavity.

FIG. 5 is a cutaway diagram of an alternative embodiment featuring an unbroken barrier surrounding the base.

FIGS. 5A and 5B are similar to 1A and 1B but demonstrate an alternative embodiment.

FIG. 6 is a cutaway of a device shown in FIGS. 3 and 4, demonstrating the refillable wall.

FIGS. 7 and 8 demonstrate the audio features of the disclosed device.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

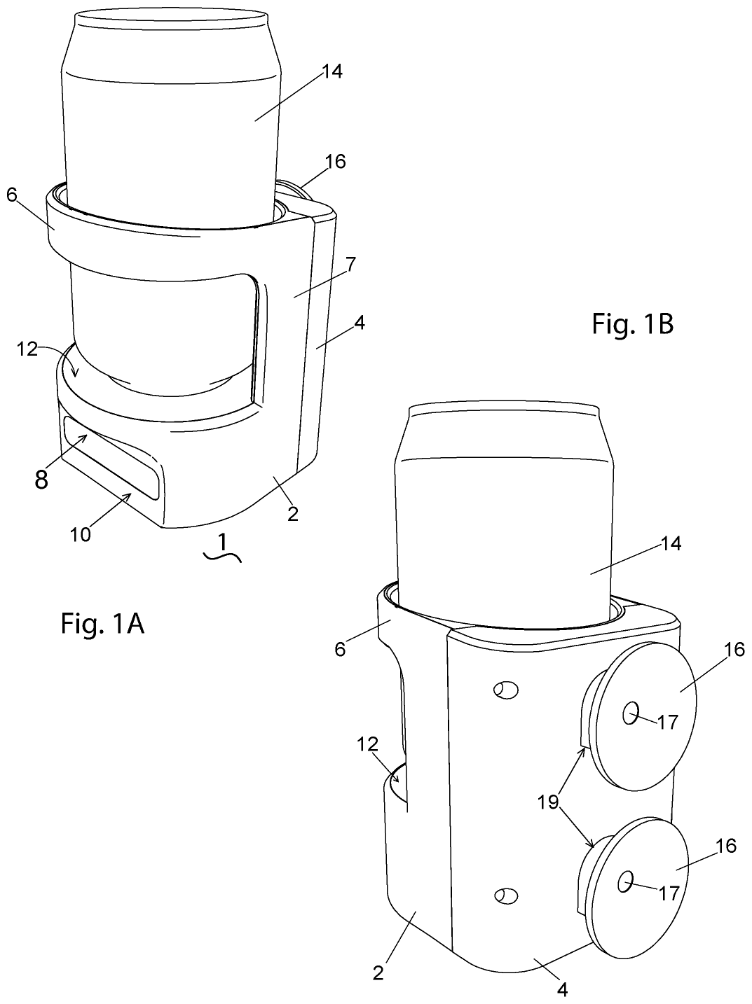

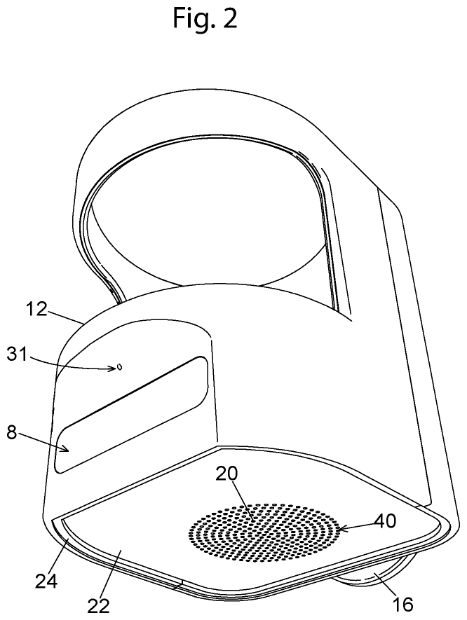

Turning now descriptively to the drawings, in which similar reference characters denote similar elements throughout the several views, FIGS. 1A and 1B illustrate a beverage holder 1, having a front panel 2, a holder strap 6 and two suction cups 16.

The front panel 2 houses the base 12, which may be an insertable component covering the audio component 8. The base section 10 of the front panel 2 may contain a heating or cooling pad to preserve or maintain an ambient temperature for beverage jar 14. The beverage jar 14 may be an aluminum can or a single serve glass or plastic bottle. The base 12 is intended for use with containers ranging between ten to twenty ounces, with equivalent figure in metric terms.

FIGS. 1A and 1B demonstrate a holder strap 6 which is rigid to maintain the upright posture of the barrier 7. In other embodiments of the device, there may be additional holder straps running directly across and diagonally around the front panel 2. The holder strap 6 may contain an adjustment mechanism or may be wholly or partially made of an elastic so as to expand and contract to accommodate beverage containers 14 of various sizes and shapes.

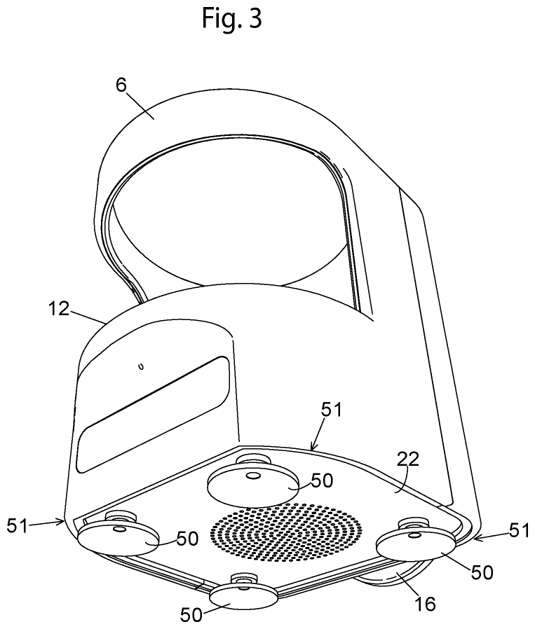

The means of mounting the beverage holder device 1 onto a wall are preferably at least one suction cup 16 mounted on the back panel 4. The suction cups may instead or additionally be mounted on a bottom surface 22 (FIG. 3). Other mounting means may be a restikable surface along the back panel 4, or a bottom surface 22. The suction cup 16 may be permanently attached via a fastener 17 or removably mounted into sockets 19 protruding from the back panel 4.

FIG. 2 demonstrates the bottom surface 22 showing a meshed speaker opening 20 and an edge 24, which exists substantially throughout the perimeter of the bottom surface 22. The perimeter edge 24 ensures that the sound emanating from the speaker opening 20 isn't muffled when a device is sitting on a surface, such as the edge of a bathtub. The edge 24 also prevents a thin film of water, which is often found on bathroom surfaces, to enter the internal cavity of the base 12, housing the audio components 8.

The audio component 8 is preferably sealed using a removable panel 26. An indicator light 31 demonstrates to a user whether the audio component is working, connected to an external source of audio content, or is reporting a technical event, such as a low battery or poor signal. These informative messages may be communicated using audio messages, through the speaker 40, or using LED messages that display varying colors or which may be blinking, intermittent or still light beam.

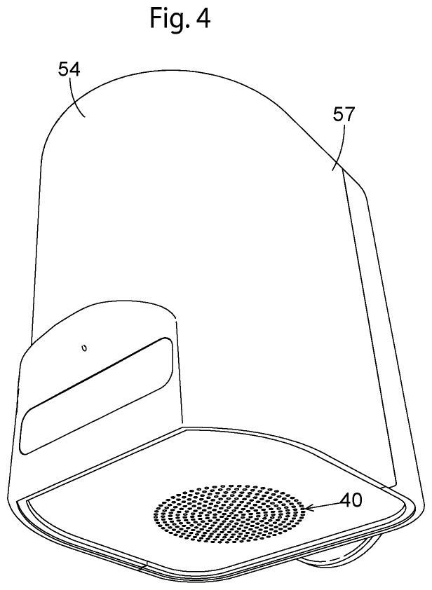

FIGS. 3-5 demonstrate additional features that may be combined with the disclosed device. FIG. 3 demonstrates suction cups 50 that are mounted on each of the four corners 51 of the base 22. High friction elements, such as resinous pegs, may be employed in place of the suction cups 50. The holder strap 6 may be replaced with a solid barrier 54 that surrounds the base 12.

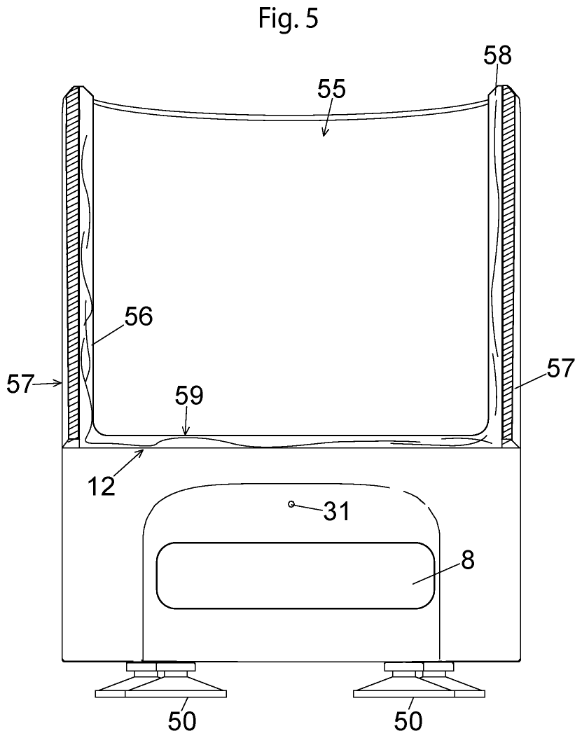

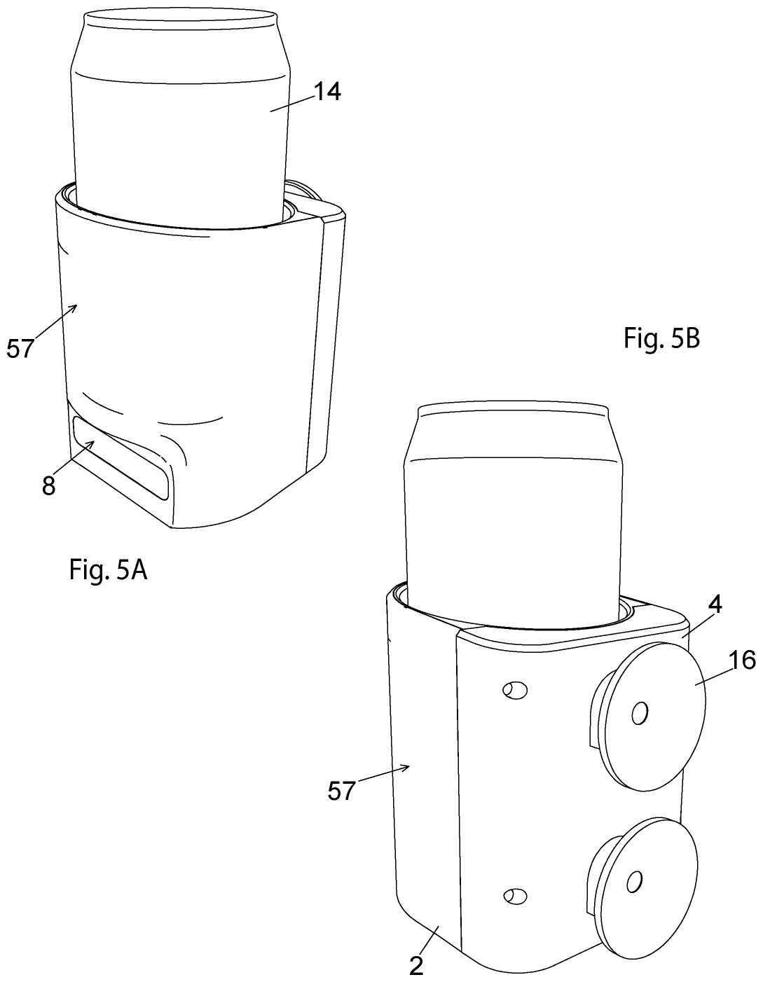

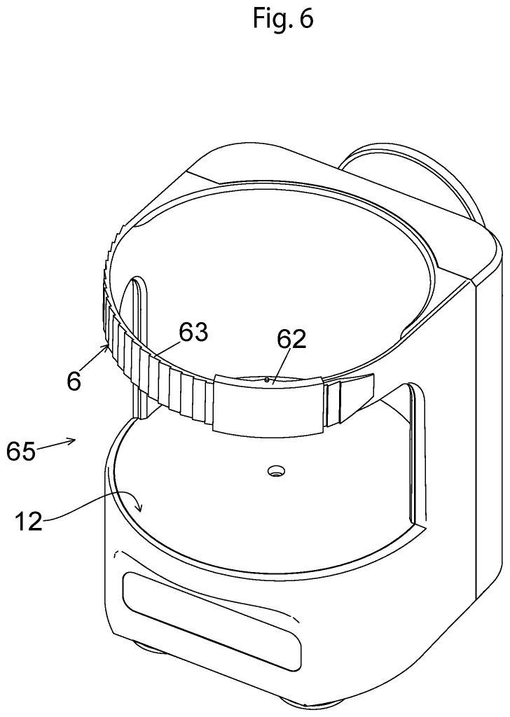

FIG. 5 is a cutaway diagram of an alternative embodiment featuring an unbroken barrier 54 surrounding the base 12. The sidewall 57 may be hollow or solid. The sidewall 57 may also contain a hollow compartment 58 containing a quantity of material that freezes when exposed to cold temperatures, such as water or a refrigerant gel. The material would fill up the cavity 58 that would be present between the inner surface 56 and the sidewall 57, and between the base 12 and the bottom surface 59. In this fashion a stored container 14 would be completement enveloped by a cold surface, thus preserving container's chilled state. The water or gel inside the hollow compartment 58 may be refillable through a spout, such that the device will not present a problem for air travelers wishing to store it in their carry-on luggage. In another alternative, the cavity 58 may be a separate insert for the inner cavity 55.

The holder strap 6 may be an adjustable component, having a belt component 64 clasped within a buckle 62. The belt buckle would be secured to a corresponding belt component 63, as shown in FIG. 6. While only holder strap 6 is shown spanning the top of the gap 63, additional holder straps may be provided.

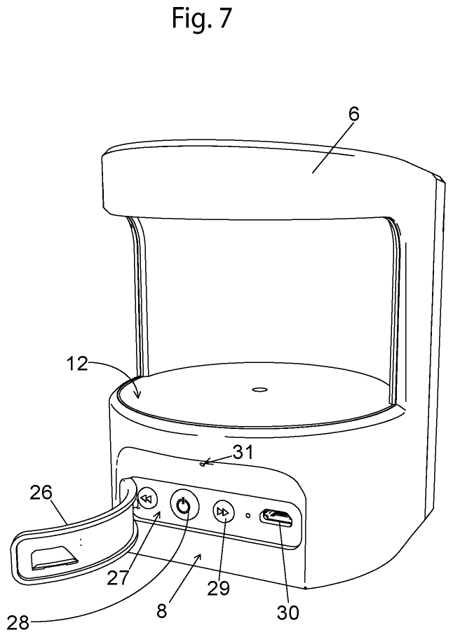

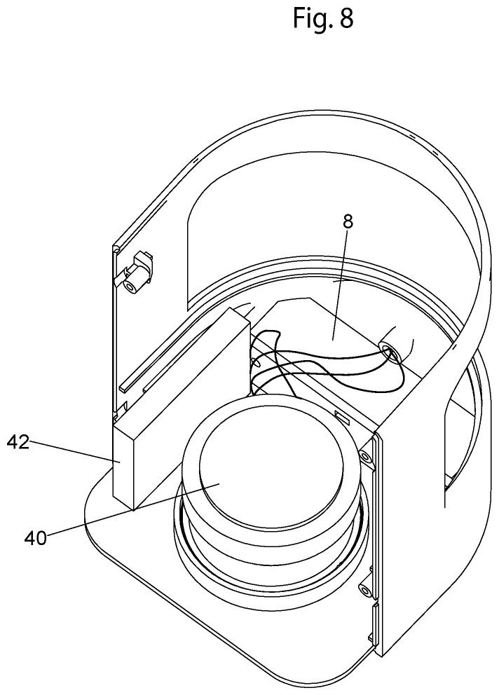

FIGS. 7 and 8 demonstrate the audio controls of the audio component 8. Shown is the removable panel 26, which conceals the recessed control pad 27. The recessed control pad 27 contains the power button 28 and tuning buttons 29. Due to the compactness of the embodiment, the buttons may have more than one functionality. For example, the power button 28 may function as a power off and on actuator and a controller for activating the short-wave radio transmission and pairing with a device transmitting nearby, otherwise known as the Bluetooth® connection, such as a mobile phone, or a digital pad. The tuning controls 29 may also carry the function of volume control. The indicator light 31 may be used to determine whether a pairing with an external radio wave transmitter has been accomplished, or whether a pairing routing has been initiated and in progress. The indicator light 31 may additionally contain a microphone, which may receive sounds that are transmitted via radio signals to a remote device. Thus the disclosed device may be paired with a remote device, such as a mobile phone, where the remote device would transmit signals to the onboard speaker 40. The sounds picked up by the microphone 31 could then also be transmitted back to the remote device, thereby utilizing the disclosed device as a Bluetooth® style communication accessory with one's mobile phone, which may be especially useful when using the disclosed device in a shower or bath, where traditional remote communication accessories would not work.

Also shown is a socket 30 for a micro-B universal serial bus connector that can be used to charge the device 1, or to connect to an external device that does not utilize short radio wave pairing. Other connectors, such as mini-B, A or micro-A may also be used. The removable panel 26 is intended to shield the control pad 27 from water splashes. The flexibility of the panel 26 allows for utilization of the control buttons 28 and 29 even while the pad 27 is covered. The flexible panel 26 may be attached on one end and held close on the other end with a tab 32 that gets inserted into the USB port 30 when the flexible panel 26 is closed.

FIG. 8 demonstrates the internal components of the device 1. Shown are the speaker 40, the rechargeable battery 42 and the audio component 8. The audio component 8 may receive audio transmission from a nearby device via short waive wireless communication or may broadcast content stored locally on board. The audio component 8 may also have the capability to access the internet through a WI FI on board connector, so as to access content accessible from the internet. The audio component 8 may also have a standard radio waive antennae for reception of the AM or FM radio signals. The indicator light 18 displays a status of the device, such as green for standard operation, amber for charging and red for error or alert.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A beverage jar holder comprising, a corpus having a base for at least one beverage jar; a barrier substantially surrounding said base; said barrier having a back panel and back panel; at least one attachment means mounted along said corpus; wherein said attachment means removably mounting onto a support surface; an audio component disposed below said base capable of receiving a radio signal and amplifying said radio signal on an onboard speaker; and wherein said corpus insulating said audio component with a removable cover.

2. The beverage jar holder of claim 1, wherein said audio component being controlled by at least two controllers disposed on said base.

3. The beverage jar holder of claim 1, wherein said attachment means is at least one suction cup mounted onto said back panel.

4. The beverage jar holder of claim 1, wherein said attachment means is at least one suction cup removably mounted onto said back panel.

5. The beverage jar holder of claim 1, wherein said attachment means is a plurality of suction cups attached to a bottom surface, said bottom surface forming a bottom of said base.

6. The beverage jar holder of claim 5, wherein said onboard speaker contains an opening through said bottom surface.

7. The beverage jar holder of claim 1, further comprising a transceiver, said transceiver receiving radio signals from a remote source and transmitting signals back to said remote source.

8. The beverage jar holder of claim 1, further comprising a holding strap, said holding strap spanning a gap in said barrier.

9. The beverage jar holder of claim 1, wherein said barrier forming a sidewall surrounding said base.

10. The beverage jar holder of claim 9, wherein said sidewall contains a cavity, wherein said cavity filled with a freezable solution.

11. The beverage jar holder of claim 10, wherein said sidewall and base forming an inner cavity for storing a beverage jar, and wherein said cavity is removably inserted into said inner cavity.

12. The beverage jar holder of claim 8, wherein a length of said holding strap may be adjustable.
